(19) United States
(12) Patent Application Publication
(10) Pub. No.: US 2026/0072435 A1
(43) Pub. Date: Mar. 12, 2026

(54) MACHINE LEARNING-BASED SYSTEM AND METHOD FOR GENERATING SEMANTIC MAPS FOR OFFROAD AUTONOMY MACHINES

(71) Applicant: Field AI, Inc., Mission Viejo, CA (US)

(72) Inventors: Amirreza Shaban, Seattle, WA (US); Chanyoung CHUNG, Santa Ana, CA (US); David Fan, Lake Forest, CA (US); Joshua SPISAK, Irvine, CA (US)

(73) Assignee: Field AI, Inc., Mission Viejo, CA (US)

(21) Appl. No.: 19/319,387

(22) Filed: Sep. 4, 2025

Related U.S. Application Data
(60) Provisional application No. 63/691,341, filed on Sep. 6, 2024.

(51) Int. Cl. G05D 1/246; G05D 107/30; G06T 3/4046; G06V 10/764; G06V 10/77; G06V 10/82; G06V 20/58; G06V 20/64

(52) U.S. Cl. CPC G05D 1/2467; G05D 1/2462; G06T 3/4046; G06V 10/764; G06V 10/7715; G06V 10/82; G06V 20/58; G06V 20/64; G05D 2107/30

(57) ABSTRACT

A mapping system for an autonomous mobile robot includes a 3D convolutional encoder network that generates 3D feature maps from 3D point cloud data. The network sequentially compresses the feature dimension of the 3D input data to reduce the computational complexity and enable feature extraction to be performed in substantially real-time. Skip connections connect the outputs of the encoder layers of the convolutional encoder network to counterpart decoder layers of a 2D convolutional decoder network. An attention-based 3D to 2D projection layer receives the 3D feature maps generated by the encoder layers via the skip connections and projects the 3D feature maps onto 2D BEV feature maps which are provided to the counterpart decoder layers as input. The projection layer automatically estimates ground level of 3D feature maps and filters out overhanging objects that are irrelevant to ground-level navigation.

### CROSS-REFERENCE TO RELATED APPLICATION

This application claims priority to and the benefit of the filing date of provisional U.S. Patent Application No. 63/691,341, entitled “MACHINE LEARNING-BASED SYSTEM AND METHOD FOR GENERATING SEMANTIC MAPS FOR OFFROAD AUTONOMY MACHINES” and filed on Sep. 5, 2024, the entire contents of which is hereby expressly incorporated herein by reference.

### TECHNICAL FIELD

The present disclosure relates generally to autonomous robots, and, in particular, to artificial intelligence-based semantic mapping systems for autonomous robots.

### BACKGROUND

Autonomous robot navigation in off-road environments has seen a wide range of applications including search and rescue, agriculture, planetary exploration, and defense. Unlike indoor or on-road environments where traversable areas and non-traversable areas are clearly separated, off-road terrains exhibit a wide range of traversability that require a comprehensive understanding of the semantics and geometry of the terrain for successful planning and control. Perceiving whether the terrain is traversable from sparse LiDAR data can be a challenging problem as off-road terrain is often characterized by rapid changes to the ground plane, heavy vegetation, overhanging branches, and negative obstacles. In other words, a successful off-road robot must reason about both the geometric and semantic content of its surroundings to determine what terrain is traversable and what is non-traversable.

Bird's-eye-view (BEV) maps are typically used in autonomous driving, robotics, and surveillance to provide a unified, top-down perspective of a 3D environment. This perspective is important for spatial reasoning, decision-making, and navigation because it removes the distortion inherent in first-person camera views. Various methods have been developed to project 3D sensor data into 2D BEV maps. Traditional approaches involve basic projection techniques that convert all 3D data points into a 2D plane without considering the relevance of each object to ground-level navigation. Existing systems also struggle with balancing computational load, resulting in latency issues and the reduced accuracy, making the existing systems unsuitable for the real-time processing.

Hence, what is needed is a BEV mapping system and method that enables 3D sensor data to be processed and projected to 2D BEV maps in substantially real-time and that accurately identify and classify objects based on traversability.

### SUMMARY

In one general aspect, the instant disclosure presents a data processing system having a processor and a memory in communication with the processor wherein the memory stores executable instructions that, when executed by the processor alone or in combination with other processors, cause the data processing system to perform multiple functions. The functions include receiving three-dimensional (3D) input data generated by a sensor system of the autonomous mobile robot at an input layer of a hybrid 3D to two-dimensional (2D) Deep Convolutional Neural Network (DCNN), the hybrid 3D to 2D DCNN including a convolutional encoder network and a convolutional decoder network connected by skip connections; successively compressing at least one dimension of the 3D input data to generate a plurality of compressed 3D feature maps using the convolutional decoder network, each of the compressed 3D feature maps having a reduced size relative to a previous compressed 3D feature map generated by the convolutional decoder network; providing the compressed 3D feature maps generated by the convolutional decoder network to an attention-based 3D to 2D projection layer via the skip connections; projecting the compressed 3D feature maps onto 2D bird's eye view (BEV) feature maps with the attention-based 3D to 2D projection layer to generate projected 2D BEV feature maps, the attention-based 3D to 2D projection layer automatically estimating a ground level for projected 2D BEV feature maps and identifying 3D data in the compressed 3D feature maps associated with overhanging objects that are irrelevant to ground-level navigation and omitting the identified 3D data from the projected 2D BEV feature maps; providing the projected 2D BEV feature maps as inputs to the convolutional decoder network; successively upsampling the projected 2D BEV feature maps to generate a plurality of upsampled 2D BEV feature maps with the convolutional decoder network, each of the upsampled 2D BEV feature maps having an increased size relative to a previously generated upsampled 2D BEV feature map; providing a last upsampled 2D BEV feature map as a final 2D BEV feature map to a traversability analysis component; analyzing the final 2D BEV feature map with reference to semantic class information pertaining to terrain and objects identified in the final 2D BEV feature map, terrain and object geometry information pertaining to the terrain and objects identified in the final 2D BEV feature map, and robot configuration and capability information pertaining to the autonomous mobile robot to identify a traversability level respectively for a plurality of geometric locations in the final 2D BEV feature map, the traversability level for each of the geometric locations being one of a plurality of different predefined traversability levels; generating a 2D BEV semantic traversability prediction map that indicates the identified traversability level of the plurality of geometric locations; and providing the 2D BEV semantic traversability prediction map to a control system of the autonomous robot to use in planning paths of movement for the autonomous mobile robot.

In yet another general aspect, the instant disclosure presents a method for generating a 2D BEV semantic traversability prediction map for an autonomous mobile robot. The method includes receiving three-dimensional (3D) input data generated by a sensor system of the autonomous mobile robot at an input layer of a hybrid 3D to two-dimensional (2D) Deep Convolutional Neural Network (DCNN), the hybrid 3D to 2D DCNN including a convolutional encoder network and a convolutional decoder network connected by skip connections; successively compressing at least one dimension of the 3D input data to generate a plurality of compressed 3D feature maps using the convolutional decoder network, each of the compressed 3D feature maps having a reduced size relative to a previous compressed 3D feature map generated by the convolutional decoder network; providing the compressed 3D feature maps generated by the convolutional decoder network to an attention-based 3D to 2D projection layer via the skip connections; projecting the compressed 3D feature maps onto 2D bird's eye view (BEV) feature maps with the attention-based 3D to 2D projection layer to generate projected 2D BEV feature maps, the attention-based 3D to 2D projection layer automatically estimating a ground level for the projected 2D BEV feature maps and identifying 3D data in the compressed 3D feature maps associated with overhanging objects that are irrelevant to ground-level navigation and omitting the identified 3D data from the projected 2D BEV feature maps; providing the projected 2D BEV feature maps as inputs to the convolutional decoder network; successively upsampling the projected 2D BEV feature maps to generate a plurality of upsampled 2D BEV feature maps with the convolutional decoder network, each of the upsampled 2D BEV feature maps having an increased size relative to a previously generated upsampled 2D BEV feature map; providing a last upsampled 2D BEV feature map as a final 2D BEV feature map to a traversability analysis component; analyzing the final 2D BEV feature map with reference to semantic class information pertaining to terrain and objects identified in the final 2D BEV feature map, terrain and object geometry information pertaining to the terrain and objects identified in the final 2D BEV feature map, and robot configuration and capability information pertaining to the autonomous mobile robot to identify a traversability level respectively for a plurality of geometric locations in the final 2D BEV feature map, the traversability level for each of the geometric locations being one of a plurality of different predefined traversability levels; generating a 2D BEV semantic traversability prediction map that indicates the identified traversability level of the plurality of geometric locations; and providing the 2D BEV semantic traversability prediction map to a control system of the autonomous robot to use in planning paths of movement for the autonomous mobile robot.

In a further general aspect, the instant application describes a non-transitory computer readable medium on which are stored instructions that when executed cause a programmable device to perform functions of receiving three-dimensional (3D) input data generated by a sensor system of an autonomous mobile robot at an input layer of a hybrid 3D to two-dimensional (2D) Deep Convolutional Neural Network (DCNN), the hybrid 3D to 2D DCNN including a convolutional encoder network and a convolutional decoder network connected by skip connections; successively compressing at least one dimension of the 3D input data to generate a plurality of compressed 3D feature maps using the convolutional decoder network, each of the compressed 3D feature maps having a reduced size relative to a previous compressed 3D feature map generated by the convolutional decoder network; providing the compressed 3D feature maps generated by the convolutional decoder network to an attention-based 3D to 2D projection layer via the skip connections; projecting the compressed 3D feature maps onto 2D bird's eye view (BEV) feature maps with the attention-based 3D to 2D projection layer to generate projected 2D BEV feature maps, the attention-based 3D to 2D projection layer automatically estimating a ground level for the projected 2D BEV feature maps and identifying 3D data in the compressed 3D feature maps associated with overhanging objects that are irrelevant to ground-level navigation and omitting the identified 3D data from the projected 2D BEV feature maps; providing the projected 2D BEV feature maps as inputs to the convolutional decoder network; successively upsampling the projected 2D BEV feature maps to generate a plurality of upsampled 2D BEV feature maps with the convolutional decoder network, each of the upsampled 2D BEV feature maps having an increased size relative to a previously generated upsampled 2D BEV feature map; providing a last upsampled 2D BEV feature map as a final 2D BEV feature map to a traversability analysis component; analyzing the final 2D BEV feature map with reference to semantic class information pertaining to terrain and objects identified in the final 2D BEV feature map, terrain and object geometry information pertaining to the terrain and objects identified in the final 2D BEV feature map, and robot configuration and capability information pertaining to the autonomous mobile robot to identify a traversability level respectively for a plurality of geometric locations in the final 2D BEV feature map, the traversability level for each of the geometric locations being one of a plurality of different predefined traversability levels; generating a 2D BEV semantic traversability prediction map that indicates the identified traversability level of the plurality of geometric locations; and providing the 2D BEV semantic traversability prediction map to a control system of the autonomous robot to use in planning paths of movement for the autonomous mobile robot.

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter. Furthermore, the claimed subject of this disclosure is not limited to implementations that solve any or all disadvantages noted in any part of this disclosure.

### BRIEF DESCRIPTION OF THE DRAWINGS

The drawing figures depict one or more implementations in accord with the present teachings, by way of example only, not by way of limitation. In the figures, like reference numerals refer to the same or similar elements. Furthermore, it should be understood that the drawings are not necessarily to scale.

FIG. 1 shows an example implementation of an autonomous mobile robot in which aspects of the disclosure may be implemented.

FIG. 2 depicts an example implementation of a BEV mapping system which may be utilized by the autonomous mobile robot of FIG. 1.

FIG. 3 depicts an example implementation of a Hybrid 3D to 2D Deep Convolutional Neural Network for the BEV mapping system of FIG. 2.

FIG. 4 shows a flowchart for an example method of generating a 2D BEV semantic traversability prediction map for the autonomous mobile robot of FIG. 1 using the Hybrid 3D to 2D Deep Convolutional Neural Network of FIG. 3.

FIG. 5 is a block diagram illustrating an example software architecture, various portions of which may be used in conjunction with various hardware architectures herein described.

FIG. 6 is a block diagram illustrating components of an example machine configured to read instructions from a machine-readable medium and perform any of the features described herein.

### DETAILED DESCRIPTION

Offroad navigation represents a significant challenge in the field of autonomous mobile machines, such as robots and vehicles (referred to herein collectively as “autonomous robots” or simply “robots”). Unlike structured environments, such as highways and urban roads, offroad terrains are unpredictable, featuring uneven surfaces, dense vegetation, and numerous obstacles. To enable movement and navigation through such environments, autonomous robots must be able to detect and classify obstacles and make real-time decisions about the safest and most efficient routes.

To this end, autonomous robots are typically provided with a Bird's Eye View (BEV) mapping system for generating top-down views of the environment, referred to as BEV maps. However, generating accurate BEV maps is a complex task for a number of reasons. For example, generating BEV maps typically involves translating three-dimensional (3D) sensor data collected by the robot's onboard sensors (e.g., light-detection and ranging (LIDAR) sensors, cameras, etc.) into a two-dimensional (2D) top-down view of the environment. The sensor data must be processed to detect objects, determine the positions of objects on the map, and classify detected objects based on traversability. It can be difficult to distinguish between obstacles that impact ground-level navigation and those that do not, such as the overhanging tree branches and tall grasses.

Various methods have been developed to project 3D sensor data into the one or more 2D BEV maps. Traditional approaches involve basic projection techniques that convert all 3D data points into a 2D plane without considering the relevance of each object to ground-level navigation. For instance, early BEV mapping systems relied primarily on object height to determine whether objects were traversable or not. However, this method of classifying objects was not capable of distinguishing between types of objects. As a result, traversable objects, such as low-hanging tree branches, bushes, and tall grass, may be classified as non-traversable because they have a height above a certain threshold, while non-traversable objects, such as significant rocks and rocky terrain, may be classified as traversable because they have a height below a threshold. This results in BEV maps having incorrect information which in turn impacts the ability of autonomous robots to navigate safely within the environment.

Another challenge faced by BEV mapping systems is enabling BEV maps to be generated in substantially real-time. Navigating in dynamic environments often requires the ability to make split-second navigation decisions to avoid obstacles and prevent accidents. However, processing 3D sensor data is by nature computationally intensive. Previously known systems were often incapable of processing sensor data fast enough to enable real-time decision-making. As a result, previously known mapping systems would often have to sacrifice accuracy by omitting sensor data or making assumptions to enable faster processing times.

The present disclosure provides technical solutions to the technical problems associated with generating 2D BEV maps that take ground level and overhanging objects into consideration. The technical solutions involve the provision of a Hybrid Real-Time 3D to 2D Deep Convolutional Neural Network (DCNN) that combines 3D and 2D data processing for real-time semantic mapping of offroad environments. The Hybrid DCNN includes a 3D convolutional encoder network that generates 3D feature maps from 3D point cloud data. The network sequentially compresses the feature dimension (i.e., the z dimension) of the 3D input data to reduce the computational complexity and enable feature extraction to be performed in substantially real-time.

Skip connections connect the outputs of the encoder layers of the convolutional encoder network to counterpart decoder layers of a 2D convolutional decoder network. An attention-based 3D to 2D projection layer receives the 3D feature maps generated by the encoder layers via the skip connections and projects the 3D feature maps onto 2D BEV feature maps which are provided to the counterpart decoder layers as input. The projection layer automatically estimates ground level of 3D feature maps and filters out overhanging objects, such as tree branches, that are irrelevant to ground-level navigation. This projection layer ensures that only obstacles pertinent to ground-level traversal are retained in the BEV map, enhancing the accuracy and safety of autonomous navigation in offroad environments.

The decoder layers of the 2D convolutional decoder network are used to upsample a low resolution 2D feature map which generated from the 3D feature map generated by the last encoder layer. Upsampling is performed to recover spatial information lost during the compression, or downsampling, of the sparse 3D input data. Traversability analysis of semantic class information pertaining features extracted from 3D input data, terrain and object geometry information derived from the final 2D feature map, and robot configuration and capability information is performed to identify traversability levels (e.g., free, low-cost, medium-cost, lethal) for geometric locations in the surrounding environment. The identified traversability levels are then used to generate a 2D BEV semantic traversability prediction map which may be used by the robot control system to make planning decisions and select low-cost routes to reach goals.

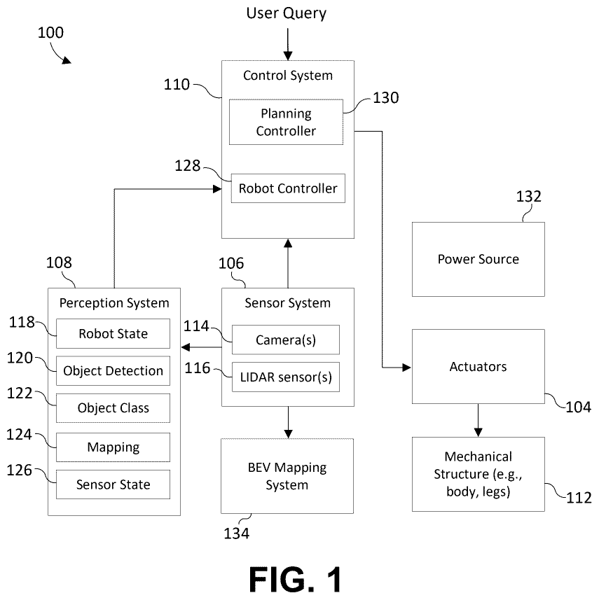

FIG. 1 shows an example implementation of a robot 100 in which aspects of this disclosure may be implemented. The robot 100 includes a mechanical structure 112, actuators 104, sensor system 106, perception system 108, control system 110, and power source 132. The mechanical structure 112 includes the structural elements which form the robot body, locomotion mechanism(s) (e.g., legs, tracks, propeller(s), joints, etc.), and other moving parts. The actuators 104 are hardware which turn energy (e.g., from power source) into physical motion of an associated robot body part or mechanism. The actuators 104 typically comprise electric motors although any suitable type of actuator, including hydraulic/pneumatic actuators, may be used. Actuators 104 can be configured to produce rotary motion, linear motion, or combinations of rotary and/linear motions.

The sensor system 106 includes a plurality of sensors which are used to sense characteristics of the environment and robot state (e.g., pose, orientation, etc.). The sensors 106 may include vision sensors (e.g., cameras), proximity sensors (e.g., ultrasonic and/or capacitive sensors), range sensors (e.g., light-detection and ranging (LIDAR) and Radar sensors), navigation and positioning sensors (e.g., global positions system (GPS) sensors), accelerometers, gyroscopes, inertial measurement units (IMUs), environment sensors (e.g., temperature, light, sound, gas sensors), force sensors, and/or kinematic sensors. In the example of FIG. 1, the sensor system 106 includes at least one camera 114 and at least on LIDAR sensor 116. Sensors can be mounted in any suitable location in and on the robot. Some sensors may have fields of view (FoV), which is the angular or spatial extent of the environment the sensor can detect or capture at any given moment. Sensors may be pivotable and/or rotatable to change the FoV without having to reposition the entire robot.

The perception system 108 receives raw data (i.e., sensor output) from the sensor system 106 and uses algorithms to convert the data to meaningful information. To this end, the perception system 108 includes a plurality of perception modules that uses a predetermined algorithm for performing a perception related task. For example, the perception system 108 may include robot state modules 118, object detection modules 120, object classification modules 122, environment mapping modules 124, and sensor state modules 126. The robot state 118 modules process relevant sensor data to estimate robot pose. Object detection modules 120 process relevant sensor data to detect objects in the environment, and object classification modules 122 process sensor data to identify detected objects (e.g., doors, stairs, fire extinguishers, control panels, etc.). Environment mapping modules 124 monitor sensor information to generate a map of the local environment. Sensor state modules 126 process sensor data to estimate sensor state (e.g., sensor odometry).

The control system 110 is a computer system (i.e., hardware and software) that receives instructions, interprets commands, processes sensor and perception data, plans actions and search behaviors, and communicates with the robot's motors and actuators to cause movements. The control system 110 receives sensor data from the sensor system 106 and perception data from the perception system 108 and uses this information as the basis for controlling the movement and actions performed by the robot. The control system may include various controllers for managing different aspects of robot performance. For example, the control system 110 may include a robot controller 128 for controlling the motion of the robot. The robot controller 128 receives instructions indicating an action to perform and generates commands for the appropriate actuators to perform to action. The robot controller 128 may be configured to identify movement paths, step positions, body poses, and the like required to perform the action. The control system 110 may include a planning controller 130 which receives user instructions or queries and identifies and makes decisions regarding the tasks to perform and/or actions to take to satisfy user instructions and queries. The planning controller 130 implements one or more frameworks, as mentioned above, for processing user instructions and queries to determine plan actions and search behaviors for the robot to execute to satisfy the user instruction or query (explained in more detail below).

The power source 132 provides the energy the robot needs to operate the actuators, sensors, and control systems. The power source 132 is typically electric power although any suitable type of power may be used (e.g., hydraulic, pneumatic, fuel cells, etc.). Electric power may be provided by one or more batteries which may be rechargeable. The amount of power that the power source provides depends on the robot's size, application, and mobility requirements.

To enable a robot to travel safely and efficiently on off-road terrains, it is important to understand the traversability of its surroundings. Terrain traversability is the amount of cost or effort to traverse over a specific landscape. While many factors affect terrain traversability, this disclosure considers three primary factors: semantics, geometry, and robot capability. The semantics of terrain refers to the classes of objects (e.g., bush, rock, tree) or materials (e.g., dirt, sand, snow) occupying the terrain. Different semantic classes typically have different physical properties, such as friction and hardness, which can affect the capabilities of a robot or vehicle. For example, since dirt can supply more friction than snow, a vehicle can drive faster on a dirt road than on snowy ground. Moreover, off-road vehicles have higher chassis and better suspension, so they can traverse over bushes and small rocks, albeit at lower speeds due to the increased resistance and bumpiness. Hence, the semantics of terrain encodes a rich spectrum of traversability.

The geometry of terrain affects traversability. Off-road terrains are typically non-flat. A vehicle may not have enough power to climb a steep slope, and driving along a slide slope at high speed poses a significant risk of rolling over. Additionally, the geometry of objects also affects traversability. For instance, a large bush is harder to traverse than a small bush. Hence, understanding the geometry of terrain is another important aspect of traversability assessment. A vehicle's physical and mechanical properties play another important role in terrain traversability. A bigger and more powerful vehicle can traverse over larger bushes or rocks than a smaller vehicle with less power. Since robot capability is an intrinsic property of the robot and is independent of terrain properties, robot capability is considered when designing the cost function which is used to determine the cost associated with different traversability levels.

A traversability mapping is defined for the system that maps the semantic classes and characteristics to predefined traversability levels. For example, for the purposes of this disclosure, four traversability levels, i.e., free, low-cost, medium-cost, and lethal, are defined to indicate the traversability of areas within the region being mapped although in various implementations any suitable number of traversability levels may be used. Semantic classes with similar costs may be mapped to the same traversability level. For example, cars and buildings may be mapped to lethal, whereas mud and grass may be mapped to low-cost.

In order for the robot to navigate efficiently and safely in a new environment (either on-road or off-road), the robot builds an online BEV semantic traversability prediction map that indicates the predicted traversability (i.e., free, low-cost, medium-cost, lethal) of the surrounding terrain. The traversability prediction map is a gravity-aligned, 2D top-down grid map which represents the terrain. The map provides the robot with instantaneous information about its surroundings. To this end, the map has a fixed size and moves with the robot such that the robot stays at the center. This is commonly referred to as the local map. The traversability prediction map be converted to a costmap by mapping each traversability level to a predefined cost value via a lookup table. The converted costmap can then be used by the planning system of the robot to determine a path to a goal having the least cost.

As shown in FIG. 1, the robot includes a BEV mapping system 134 for generating the BEV semantic traversability prediction maps to facilitate navigation and route planning for the robot. As explained below, the BEV mapping system 134 receives 3D sensor data (e.g., LiDAR output) from the sensor system 106 and processes the sensor data to generate 3D feature maps which represent the surrounding environment using x, y, and z dimensions indicative of features and characteristics of the terrain and detected objects. The 3D feature maps are projected onto 2D BEV feature maps. Semantic classes are associated with terrain and object types found in the environment. The semantic information and geometry information pertaining to the terrain and object types found in the environment are then analyzed along with robot configuration and capability information to determine a traversability level (e.g. free, low-cost, medium-cost, lethal) for the geometric locations associated with the terrain and object types found in the environment. The BEV semantic traversability prediction map may then be generated which shows the traversability levels associated with the surrounding environment. This map may be used by the robot to make planning decisions and route selections. Costs may be associated with traversability levels which in turn enables paths with the lowest costs to be planned and/or selected.

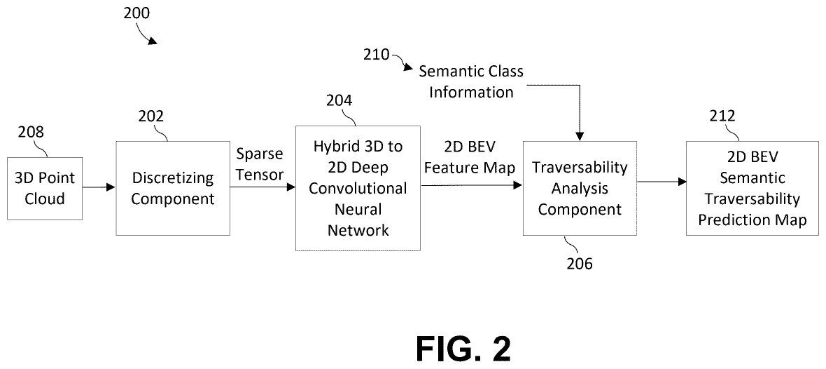

An example implementation a BEV mapping system 200 is shown in FIG. 2. The BEV mapping system 200 includes a discretizing component 202, a Hybrid 3D to 2D DCNN 204, and a traversability analysis component 206. The discretizing component 202 receives a 3D point cloud 208 generated by the robot's LiDAR. In some implementations, 3D data generated by other sensors can be included in the 3D point cloud 208. The discretizing component 202 discretizes the 3D point cloud 208 into a sparse tensor. A voxel represents a discrete unit of volume that makes up a tensor. To generate the sparse tensor, a 3D grid having a predefined size and resolution is placed over the 3D point cloud. The grid size corresponds to the number of voxels in the x, y, and z dimensions. For example, in various implementations, the 3D grid may have a size of 512×512×31, where the x and y dimensions are 512 voxels and the z dimension is 31 voxels. Voxel resolution refers to the size of the individual voxels within the grid and typically corresponds to the length of one side of the voxel. In various implementations, the voxels may have a predefined resolution of 0.2 m. In other implementations, the 3D grid may have any suitable grid size and voxel resolution.

When the 3D tensor is placed over the 3D point cloud, each of the points in the cloud is located in one of the voxels, resulting in some of the voxels containing one or more points while other voxels will contain no points. The discretization component 202 uses a sparse discretization technique on the 3D grid to generate a sparse tensor representation of the 3D voxel grid. A sparse tensor is a high-dimensional extension of the 3D grid where non-zero elements are represented as a set of indices and associated values. The discretization algorithm identifies which voxels contain at least one point from the 3D point cloud and designates these voxels as “active” while voxels with no points are designated “inactive.” Each active voxel is then assigned attributes based on the data points it contains. In this case, each active voxel is represented by a feature f which is derived from four attributes of the data points within the voxel: the average values of the x, y, and z coordinates, respectively, and the average value of the remission r of the data points within the voxel, i.e., f=1/nΣᵢ₌₁ⁿ[xᵢ, yᵢ, zᵢ, rᵢ]. The remission for a point corresponds to the reflection or back-scattering of light associated with the point.

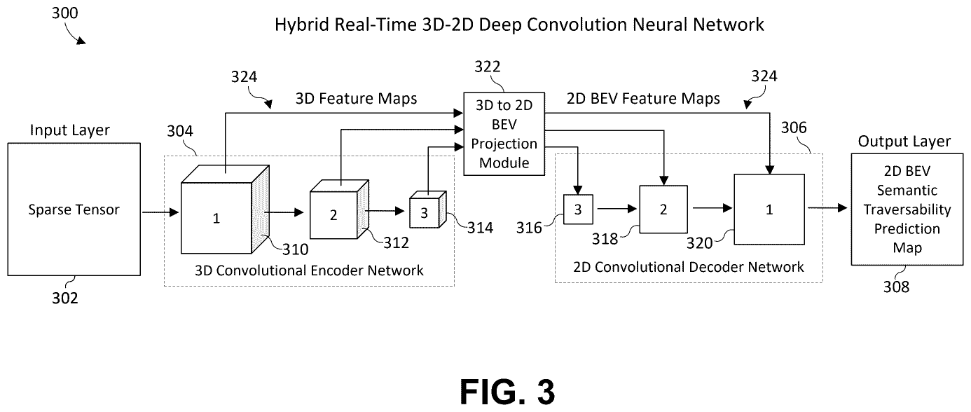

The sparse tensor is fed to the Hybrid DCNN 204. As explained below with regard to FIG. 3, the Hybrid DCNN utilizes a 3D convolutional encoder network to sequentially compress, or downsample, the z dimension of the 3D input, which reduces the computational complexity of the processing and in turn the computing resources and network bandwidth needed to generate the 3D feature maps. The Hybrid DCNN utilizes a 2D convolutional decoder network to sequentially upsample a 2D BEV feature map to recover spatial information lost during the convolution encoder operations. Each encoder layer in the convolutional encoder network has a counterpart decoder layer in the convolutional decoder network. Skip connections are used to pass feature maps directly from each encoder layer to the counterpart decoder layer.

An attention-based 3D to 2D projection layer is used to project the 3D feature maps generated by the encoder layers into 2D BEV feature maps which are provided as inputs to the counterpart decoder layers. The projection layer uses attention mechanisms to automatically estimate ground level of 3D feature maps and to filter out overhanging objects, such as tree branches, that are irrelevant to ground-level navigation. This projection layer ensures that only obstacles pertinent to ground-level traversal are retained in the 2D BEV feature map, enhancing the accuracy and safety of autonomous navigation in offroad environments. The output of the Hybrid DCNN is a final 2D BEV feature map having the same dimensions as the sparse input tensor.

The 2D BEV feature map is provided to the traversability analysis component 206. The traversability analysis component 206 receives semantic class information 210 associated with the geometric locations of the terrain types and object types detected in the 2D BEV feature map. The traversability analysis component analyzes the semantic class information, the terrain and object geometry indicated by the 2D BEV feature map, and the capabilities of the robot to determine traversability levels (e.g., free, low-cost, medium-cost, and lethal) to associate with the geometric locations. The semantic class information may indicate terrain/object types (e.g., rock, tree, tree branch, bush, sand, dirt, snow, car, building, and the like). Semantic classes may have inherent physical properties which can be included in the analysis. For example, sand, dirt, and snow have different surface characteristics, such as hardness and friction, which can impact traversability. Terrain and object geometry may include steepness of slopes, unevenness of surfaces, dimensions of objects (e.g., width and/or height of rocks, trees, bushes, and the like), and other factors related to terrain and object geometry which can impact traversability. Robot capabilities include robot size, shape, mobility mechanisms (e.g., legs, tracks, wheels, etc.), power, battery life, and the like. Different robot configurations may be better or worse suited for navigating different types of terrain and terrain geometries than others.

The traversability analysis component may implement any suitable method of assigning traversability levels to geometric locations based on the semantic class information, terrain and object geometry information, and robot configuration and capability information may be used. For example, in various implementations, the terrain analysis component 206 may be implemented using a machine learning (ML) model or artificial intelligence (AI) model which has been trained to associate a traversability level to a geometric location based on the combination of attributes and variable values determined for the geometric location, such as semantic class(es), physical properties of the semantic class(es), terrain and object geometries, robot configuration and capabilities, and the like.

Once traversability levels have been assigned to the geometric locations of the identified terrain types and object types, the traversability analysis component 206 generates the 2D BEV semantic traversability prediction map 212 which indicates the traversability of the environment surrounding the robot. In various implementations, the 2D BEV semantic traversability prediction map 212 associates different image characteristics, such as color, with each traversability level and generates a color-coded map indicating the traversability of the environment. The 2D BEV semantic traversability prediction map 212 may be stored in a suitable storage location that is accessible by the control system of the robot so that the 2D BEV semantic traversability prediction map may be accessed as needed for route planning.

An example implementation of the Hybrid 3D to 2D DCNN 300 is shown in FIG. 3. The Hybrid DCNN 300 includes an input layer 302, a 3D convolutional encoder network 304, a 2D convolutional decoder network 306, and an output layer 308. The input layer 302 receives a sparse tensor that includes the data from the 3D point cloud and provides the sparse tensor to the 3D convolutional encoder network 304. The 3D convolution encoder network 304 includes a sequence of sparse convolution encoder layers 310, 312, 314. Sparse convolution layers are a variation of standard convolutional layers designed for data with a large number of zero-valued entries, such as 3D point clouds. Unlike traditional, “dense” convolutions that compute operations for all input voxels, sparse convolutions skip computations for zero-valued voxels, saving significant memory and processing time. Each of the sparse convolution layers 310, 312, 314 in the 3D convolution encoder network 304 receives a 3D feature map (i.e., sparse tensor) as input and compresses the 3D feature map via strided convolution to extract features from relevant dimensions (i.e., the z dimension in this case) of the voxels and reduce at least one of the dimensions of the feature map before providing the compressed feature map as input to the next convolution layer in the sequence. The compressed 3D feature map generated by each encoder layer 310, 312, 314 corresponds to a sparse feature tensor having predetermined x, y, and z dimensions, with the z dimension of the output tensor (i.e., output feature map) being downsampled, or compressed, relative to the z dimension of the input tensor (i.e., input feature map). In various implementations, the sparse feature tensor S output by each sparse convolution layer has a size 512×512×C, where C is the size of the z dimension. The first convolution encoder layer 310 receives the sparse tensor provided as input to the Hybrid DCNN. The 3D feature map output by the encoder layers 310 and 312 is provided as an input 3D feature map for the next encoder layer in the sequence, i.e., encoder layer 312 and encoder layer 314, respectively.

In various implementations, each encoder layer 310, 312, 314 performs a convolution that involves applying a learnable 3D filter (i.e., kernel) to the voxels of the input 3D feature map. The 3D filter is weight matrix of a predetermined size (e.g., 2×2, 3×3, etc.) having predetermined weights in each matrix element. In various implementations, the 3D filter is placed over a submatrix in the input feature map and an element-wise product of the filter weights and the feature values in the submatrix is computed to determine a value for submatrix. The 3D filter is then moved to the next submatrix to determine a value for the next submatrix. The operation is repeated until the 3D filter has covered every voxel in the input 3D feature map.

To compress the z-dimension of the voxels in the input 3D feature map, the 3D filter is applied using strided convolution. In strided convolution, instead of the 3D filter moving one voxel at a time over the input feature map, the 3D filter is moved by skipping or jumping over two or more voxels in at least one of the x, y, and z dimensions of the voxel. To compress the z dimension, the 3D filter may be moved so that it skips over one or more voxels in the z dimension of the input feature map. The number of voxels that are skipped or jumped over is set based on a predetermined stride parameter which can dictate the size of the jump along each of the three dimensions x, y, and z. This process is repeated until all voxels in the input feature map have been processed (or jumped over). Each voxel in the compressed feature map represents multiple voxels from the input feature map. One of the key benefits of strided convolution is reduced computational complexity. By skipping pixels, the network can process larger images more efficiently. This can be particularly important in real-time applications, such as the generation of traversability prediction maps for offroad navigation. In addition, strided convolution downsamples the input feature map so that only the most relevant data is retained. With each successive encoder layer, the downsampling results in increasingly complex and rich features to be extracted from the input data.

The 2D convolution decoder network 306 includes a sequence of sparse convolution decoder layers 316, 318, 320. The encoder layers 310, 312, 314 of the 3D convolution encoder network 304 and the decoder layers 316, 318, 320 of the 2D convolution decoder network 306 have a one-to-one correspondence. Thus, each encoder layer 310, 312, 314 has a counterpart decoder layer 316, 318, 320, respectively, that operates in the same resolution as the encoder layer. Each of the decoder layers 316, 318, 320 in the 2D convolution encoder network 304 receives an input 2D feature map (i.e., sparse tensor) and performs an upsampling operation on the input feature map that increases the spatial dimensions of the input feature map. In various implementations, the upsampling operation corresponds to a transposed convolution. Transposed convolution involves inserting zeros between elements in the input feature map to increase at least one dimension of the input feature map. A 3D filter, or kernel, is then applied to the feature map to produce an upsampled feature map. The process is essentially the reverse of the strided convolution process used to compress the 3D feature map. The goal of transposed convolution is to recover the spatial information lost during the convolution operation. The upsampled 2D feature map generated by each decoder layer 316, 318, 320 corresponds to a sparse feature tensor having predetermined x, y, and z dimensions, with the z dimension of the output tensor (i.e., output feature map) being upsampled relative to the z dimension of the input tensor (i.e., input feature map). The output 2D feature map of decoder layers 316 and 318 are provided as the input feature map for the decoder layers 318 and 320, respectively. While convolution encoders use a kernel to slide over and compute the weighted sum of the input, producing a smaller feature map, transposed convolution performs this process in reverse, generating a larger feature map from a smaller one.

Skip connections 324 connect each encoder layer 310, 312, 314 in the convolution encoder network 304 to its counterpart decoder layer 316, 318, 320 in the convolution decoder network 306. An attention-based 3D to 2D projection layer 322 receives the 3D feature maps generated by the encoder layers 310, 312, 314 via the skip connections 324 and converts the 3D feature maps to projected 2D feature maps which are provided as an inputs to the corresponding counterpart decoder layers 316, 318, 320 via the skip connections 324. The attention-based projection layer 322 includes a projection component which performs a down projection on each voxel in the 3D feature map to find the x and y coordinates of the voxel in a 2D feature map. The projection layer 322 includes attention mechanisms which enable the projection layer 322 to automatically estimate the ground level of the terrain represented by the voxels of the 3D feature map. The projection layer 322 may also use attention to filter out data points associated with overhanging objects, such as tree branches, that are above a predetermined height relative to the ground level and therefore irrelevant to ground-level navigation. The projection layer 322 ensures that only obstacles pertinent to ground-level traversal are retained in the 2D BEV feature maps which are provided to the decoder layers of the convolution decoder network 306, thus enhancing the accuracy and safety of autonomous navigation in offroad environments. Attention mechanisms, in the form of transformers or deformable attention, allow the system to dynamically learn how to weigh and aggregate 3D data when constructing the 2D BEV features. This enables the system to focus on relevant information and handle variations in depth and perspective.

The projected 2D feature map received by a decoder layer 316, 318, 320 can be used by the decoder layer to facilitate and/or guide the transposed convolution process. For example, decoder layers 318 and 320 receives a projected 2D feature map generated by the attention-based 3D to 2D projection layer 322 in addition to the input 2D feature map received from the previous decoder layer. The projected 2D feature map and the input 2D feature map be combined to generate an upsampled 2D BEV feature map. For example, in some implementations, the two 2D feature maps may be combined, e.g., by concatenating or stacking, to generate a single, richer feature representation. In other implementations, the convolution decoder layers may be trained to process the input 2D BEV feature map conditioned on the projected 2D BEV feature map.

In any case, the output of the last decoder layer 322 in the convolution decoder network 306 corresponds to the final 2D BEV feature map. The final 2D BEV feature map which is provided to the traversability analysis component 206 where it is analyzed along semantic class information, terrain and object geometry information, and robot configuration and capability information to determine traversability levels for geometric locations in the surrounding environment, as described above.

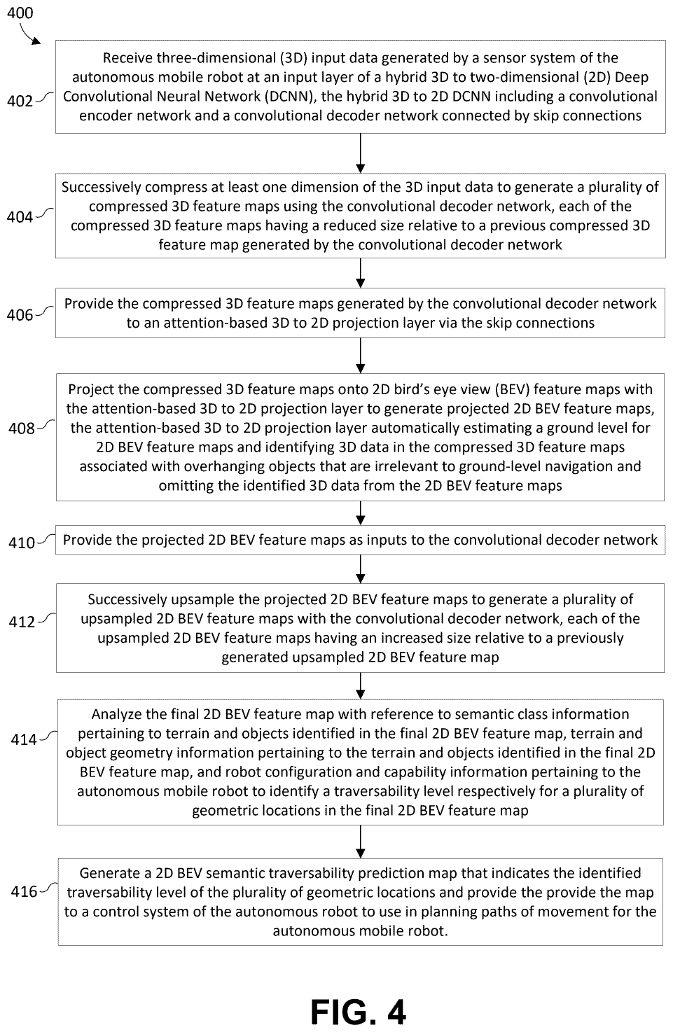

FIG. 4 is a flowchart of an example method of generating a 2D BEV semantic traversability prediction map using the Hybrid DCNN. The method begins with receiving three-dimensional (3D) input data generated by a sensor system of the autonomous mobile robot at an input layer of the hybrid DCNN (block 402). At least one dimension of the 3D input data is successively compressed to generate a plurality of compressed 3D feature maps using a convolutional decoder network of the hybrid DCNN (block 404). Each of the compressed 3D feature maps has a reduced size relative to a previous compressed 3D feature map generated by the convolutional decoder network. The compressed 3D feature maps generated by the convolutional decoder network are provided to an attention-based 3D to 2D projection layer via the skip connections (block 406). The compressed 3D feature maps are projected onto 2D bird's eye view (BEV) feature maps using the attention-based 3D to 2D projection layer to generate projected 2D BEV feature maps (block 408). The attention-based 3D to 2D projection layer automatically estimates a ground level for 2D BEV feature maps and identifies 3D data in the compressed 3D feature maps associated with overhanging objects that are irrelevant to ground-level navigation and omits the identified 3D data from the 2D BEV feature maps. The projected 2D BEV feature maps are provided as inputs to a convolutional decoder network of the hybrid DCNN (block 410). The projected 2D BEV feature maps are successively upsampled to generate a plurality of upsampled 2D BEV feature maps using the convolutional decoder network (block 412). Each of the upsampled 2D BEV feature maps has an increased size relative to a previously generated upsampled 2D BEV feature map. The final 2D BEV feature map is then analyzed with reference to semantic class information pertaining to terrain and objects identified in the final 2D BEV feature map, terrain and object geometry information pertaining to the terrain and objects identified in the final 2D BEV feature map, and robot configuration and capability information pertaining to the autonomous mobile robot to identify a traversability level respectively for a plurality of geometric locations in the final 2D BEV feature map (block 414). The traversability level for each of the geometric locations is one of a plurality of different predefined traversability levels.

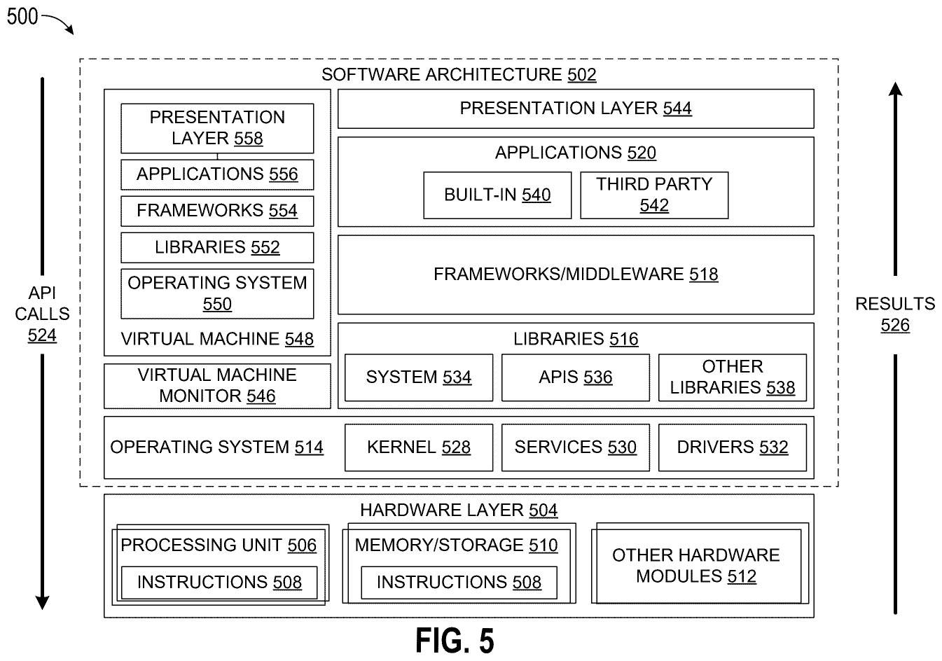

FIG. 5 is a block diagram 500 illustrating an example software architecture 502, various portions of which may be used in conjunction with various hardware architectures herein described, which may implement any of the above-described features. FIG. 5 is a non-limiting example of a software architecture and it will be appreciated that many other architectures may be implemented to facilitate the functionality described herein. The software architecture 502 may execute on hardware such as client devices, native application provider, web servers, server clusters, external services, and other servers. A representative hardware layer 504 includes a processing unit 506 and associated executable instructions 508. The executable instructions 508 represent executable instructions of the software architecture 502, including implementation of the methods, modules and so forth described herein.

The hardware layer 504 also includes a memory/storage 510, which also includes the executable instructions 508 and accompanying data. The hardware layer 504 may also include other hardware modules 512. Instructions 508 held by processing unit 506 may be portions of instructions 508 held by the memory/storage 510.

The example software architecture 502 may be conceptualized as layers, each providing various functionality. For example, the software architecture 502 may include layers and components such as an operating system (OS) 514, libraries 516, frameworks 518, applications 520, and a presentation layer 544. Operationally, the applications 520 and/or other components within the layers may invoke API calls 524 to other layers and receive corresponding results 526. The layers illustrated are representative in nature and other software architectures may include additional or different layers. For example, some mobile or special purpose operating systems may not provide the frameworks/middleware 518.

The OS 514 may manage hardware resources and provide common services. The OS 514 may include, for example, a kernel 528, services 530, and drivers 532. The kernel 528 may act as an abstraction layer between the hardware layer 504 and other software layers. For example, the kernel 528 may be responsible for memory management, processor management (for example, scheduling), component management, networking, security settings, and so on. The services 530 may provide other common services for the other software layers. The drivers 532 may be responsible for controlling or interfacing with the underlying hardware layer 504. For instance, the drivers 532 may include display drivers, camera drivers, memory/storage drivers, peripheral device drivers (for example, via Universal Serial Bus (USB)), network and/or wireless communication drivers, audio drivers, and so forth depending on the hardware and/or software configuration.

The libraries 516 may provide a common infrastructure that may be used by the applications 520 and/or other components and/or layers. The libraries 516 typically provide functionality for use by other software modules to perform tasks, rather than rather than interacting directly with the OS 514. The libraries 516 may include system libraries 534 (for example, C standard library) that may provide functions such as memory allocation, string manipulation, and file operations. In addition, the libraries 516 may include API libraries 536 such as media libraries (for example, supporting presentation and manipulation of image, sound, and/or video data formats), graphics libraries (for example, an OpenGL library for rendering 2D and 3D graphics on a display), database libraries (for example, SQLite or other relational database functions), and web libraries (for example, WebKit that may provide web browsing functionality). The libraries 516 may also include a wide variety of other libraries 538 to provide many functions for applications 520 and other software modules.

The frameworks 518 (also sometimes referred to as middleware) provide a higher-level common infrastructure that may be used by the applications 520 and/or other software modules. For example, the frameworks 518 may provide various graphic user interface (GUI) functions, high-level resource management, or high-level location services. The frameworks 518 may provide a broad spectrum of other APIs for applications 520 and/or other software modules.

The applications 520 include built-in applications 540 and/or third-party applications 542. Examples of built-in applications 540 may include, but are not limited to, a contacts application, a browser application, a location application, a media application, a messaging application, and/or a game application. Third-party applications 542 may include any applications developed by an entity other than the vendor of the particular system. The applications 520 may use functions available via OS 514, libraries 516, frameworks 518, and presentation layer 544 to create user interfaces to interact with users.

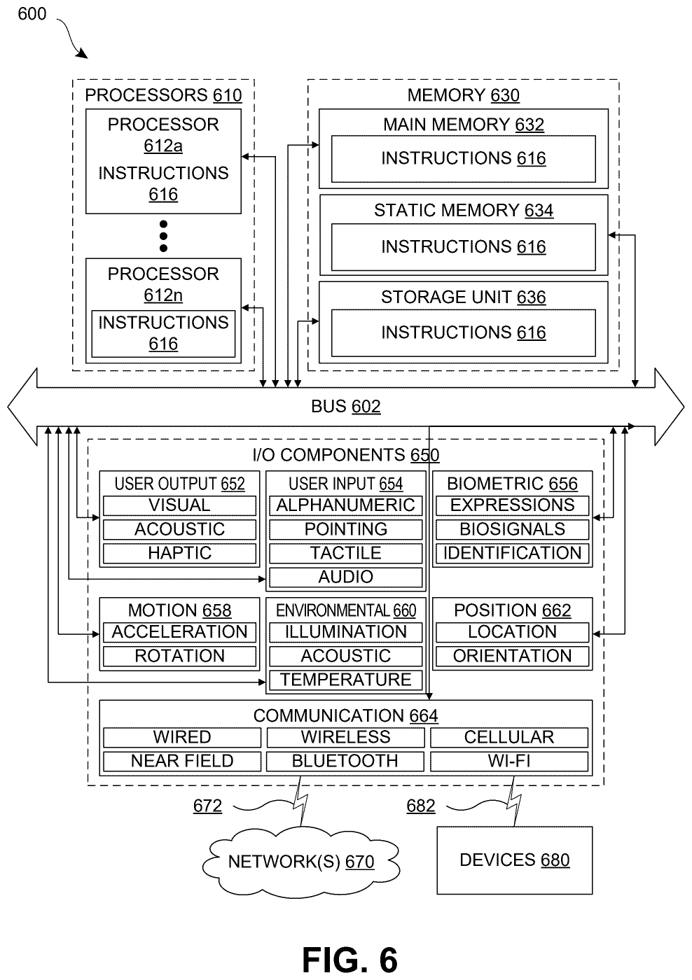

Some software architectures use virtual machines, as illustrated by a virtual machine 548. The virtual machine 548 provides an execution environment where applications/modules can execute as if they were executing on a hardware machine (such as the machine depicted in block diagram 600 of FIG. 6, for example). The virtual machine 548 may be hosted by a host OS (for example, OS 514) or hypervisor, and may have a virtual machine monitor 546 which manages operation of the virtual machine 548 and interoperation with the host operating system. A software architecture, which may be different from software architecture 502 outside of the virtual machine, executes within the virtual machine 548 such as an OS 550, libraries 552, frameworks 554, applications 556, and/or a presentation layer 558.

FIG. 6 is a block diagram illustrating components of an example machine 600 configured to read instructions from a machine-readable medium (for example, a machine-readable storage medium) and perform any of the features described herein. The example machine 600 is in a form of a computer system, within which instructions 616 (for example, in the form of software components) for causing the machine 600 to perform any of the features described herein may be executed. As such, the instructions 616 may be used to implement methods or components described herein. The instructions 616 cause unprogrammed and/or unconfigured machine 600 to operate as a particular machine configured to carry out the described features. The machine 600 may be configured to operate as a standalone device or may be coupled (for example, networked) to other machines. In a networked deployment, the machine 600 may operate in the capacity of a server machine or a client machine in a server-client network environment, or as a node in a peer-to-peer or distributed network environment. Machine 600 may be embodied as, for example, a server computer, a client computer, a personal computer (PC), a tablet computer, a laptop computer, a netbook, a set-top box (STB), a gaming and/or entertainment system, a smart phone, a mobile device, a wearable device (for example, a smart watch), and an Internet of Things (IoT) device. Further, although only a single machine 600 is illustrated, the term “machine” includes a collection of machines that individually or jointly execute the instructions 616.

The machine 600 may include processors 610, memory 630, and I/O components 650, which may be communicatively coupled via, for example, a bus 602. The bus 602 may include multiple buses coupling various elements of machine 600 via various bus technologies and protocols. In an example, the processors 610 (including, for example, a central processing unit (CPU), a graphics processing unit (GPU), a digital signal processor (DSP), an ASIC, or a suitable combination thereof) may include one or more processors 612a to 612n that may execute the instructions 616 and process data. In some examples, one or more processors 610 may execute instructions provided or identified by one or more other processors 610. The term “processor” includes a multi-core processor including cores that may execute instructions contemporaneously. Although FIG. 6 shows multiple processors, the machine 600 may include a single processor with a single core, a single processor with multiple cores (for example, a multi-core processor), multiple processors each with a single core, multiple processors each with multiple cores, or any combination thereof. In some examples, the machine 600 may include multiple processors distributed among multiple machines.

The memory/storage 630 may include a main memory 632, a static memory 634, or other memory, and a storage unit 636, both accessible to the processors 610 such as via the bus 602. The storage unit 636 and memory 632, 634 store instructions 616 embodying any one or more of the functions described herein. The memory/storage 630 may also store temporary, intermediate, and/or long-term data for processors 610. The instructions 616 may also reside, completely or partially, within the memory 632, 634, within the storage unit 636, within at least one of the processors 610 (for example, within a command buffer or cache memory), within memory at least one of I/O components 650, or any suitable combination thereof, during execution thereof. Accordingly, the memory 632, 634, the storage unit 636, memory in processors 610, and memory in I/O components 650 are examples of machine-readable media.

As used herein, “machine-readable medium” refers to a device able to temporarily or permanently store instructions and data that cause machine 600 to operate in a specific fashion. The term “machine-readable medium,” as used herein, does not encompass transitory electrical or electromagnetic signals per se (such as on a carrier wave propagating through a medium); the term “machine-readable medium” may therefore be considered tangible and non-transitory. Non-limiting examples of a non-transitory, tangible machine-readable medium may include, but are not limited to, nonvolatile memory (such as flash memory or read-only memory (ROM)), volatile memory (such as a static random-access memory (RAM) or a dynamic RAM), buffer memory, cache memory, optical storage media, magnetic storage media and devices, network-accessible or cloud storage, other types of storage, and/or any suitable combination thereof. The term “machine-readable medium” applies to a single medium, or combination of multiple media, used to store instructions (for example, instructions 616) for execution by a machine 600 such that the instructions, when executed by one or more processors 610 of the machine 600, cause the machine 600 to perform and one or more of the features described herein. Accordingly, a “machine-readable medium” may refer to a single storage device, as well as “cloud-based” storage systems or storage networks that include multiple storage apparatus or devices.

The I/O components 650 may include a wide variety of hardware components adapted to receive input, provide output, produce output, transmit information, exchange information, capture measurements, and so on. The specific I/O components 650 included in a particular machine will depend on the type and/or function of the machine. For example, mobile devices such as mobile phones may include a touch input device, whereas a headless server or IoT device may not include such a touch input device. The particular examples of I/O components illustrated in FIG. 6 are in no way limiting, and other types of components may be included in machine 600. The grouping of I/O components 650 are merely for simplifying this discussion, and the grouping is in no way limiting. In various examples, the I/O components 650 may include user output components 652 and user input components 654. User output components 652 may include, for example, display components for displaying information (for example, a liquid crystal display (LCD) or a projector), acoustic components (for example, speakers), haptic components (for example, a vibratory motor or force-feedback device), and/or other signal generators. User input components 654 may include, for example, alphanumeric input components (for example, a keyboard or a touch screen), pointing components (for example, a mouse device, a touchpad, or another pointing instrument), and/or tactile input components (for example, a physical button or a touch screen that provides location and/or force of touches or touch gestures) configured for receiving various user inputs, such as user commands and/or selections.

In some examples, the I/O components 650 may include biometric components 656, motion components 658, environmental components 660 and/or position components 662, among a wide array of other environmental sensor components. The biometric components 656 may include, for example, components to detect body expressions (for example, facial expressions, vocal expressions, hand or body gestures, or eye tracking), measure biosignals (for example, heart rate or brain waves), and identify a person (for example, via voice-, retina-, and/or facial-based identification). The position components 662 may include, for example, location sensors (for example, a Global Position System (GPS) receiver), altitude sensors (for example, an air pressure sensor from which altitude may be derived), and/or orientation sensors (for example, magnetometers). The motion components 658 may include, for example, motion sensors such as acceleration and rotation sensors. The environmental components 660 may include, for example, illumination sensors, acoustic sensors and/or temperature sensors.

The I/O components 650 may include communication components 664, implementing a wide variety of technologies operable to couple the machine 600 to network(s) 670 and/or device(s) 680 via respective communicative couplings 672 and 682. The communication components 664 may include one or more network interface components or other suitable devices to interface with the network(s) 670. The communication components 664 may include, for example, components adapted to provide wired communication, wireless communication, cellular communication, Near Field Communication (NFC), Bluetooth communication, Wi-Fi, and/or communication via other modalities. The device(s) 680 may include other machines or various peripheral devices (for example, coupled via USB).

In some examples, the communication components 664 may detect identifiers or include components adapted to detect identifiers. For example, the communication components 664 may include Radio Frequency Identification (RFID) tag readers, NFC detectors, optical sensors (for example, one- or multi-dimensional bar codes, or other optical codes), and/or acoustic detectors (for example, microphones to identify tagged audio signals). In some examples, location information may be determined based on information from the communication components 664 such as, but not limited to, geo-location via Internet Protocol (IP) address, location via Wi-Fi, cellular, NFC, Bluetooth, or other wireless station identification and/or signal triangulation.

While various embodiments have been described, the description is intended to be exemplary, rather than limiting, and it is understood that many more embodiments and implementations are possible that are within the scope of the embodiments. Although many possible combinations of features are shown in the accompanying figures and discussed in this detailed description, many other combinations of the disclosed features are possible. Any feature of any embodiment may be used in combination with or substituted for any other feature or element in any other embodiment unless specifically restricted. Therefore, it will be understood that any of the features shown and/or discussed in the present disclosure may be implemented together in any suitable combination. Accordingly, the embodiments are not to be restricted except in light of the attached claims and their equivalents. Also, various modifications and changes may be made within the scope of the attached claims.

While the foregoing has described what are considered to be the best mode and/or other examples, it is understood that various modifications may be made therein and that the subject matter disclosed herein may be implemented in various forms and examples, and that the teachings may be applied in numerous applications, only some of which have been described herein. It is intended by the following claims to claim any and all applications, modifications and variations that fall within the true scope of the present teachings.

Unless otherwise stated, all measurements, values, ratings, positions, magnitudes, sizes, and other specifications that are set forth in this specification, including in the claims that follow, are approximate, not exact. They are intended to have a reasonable range that is consistent with the functions to which they relate and with what is customary in the art to which they pertain.

The scope of protection is limited solely by the claims that now follow. That scope is intended and should be interpreted to be as broad as is consistent with the ordinary meaning of the language that is used in the claims when interpreted in light of this specification and the prosecution history that follows and to encompass all structural and functional equivalents. Notwithstanding, none of the claims are intended to embrace subject matter that fails to satisfy the requirement of Sections 101, 102, or 103 of the Patent Act, nor should they be interpreted in such a way. Any unintended embracement of such subject matter is hereby disclaimed.

Except as stated immediately above, nothing that has been stated or illustrated is intended or should be interpreted to cause a dedication of any component, step, feature, object, benefit, advantage, or equivalent to the public, regardless of whether it is or is not recited in the claims.

It will be understood that the terms and expressions used herein have the ordinary meaning as is accorded to such terms and expressions with respect to their corresponding respective areas of inquiry and study except where specific meanings have otherwise been set forth herein. Relational terms such as first and second and the like may be used solely to distinguish one entity or action from another without necessarily requiring or implying any actual such relationship or order between such entities or actions. The terms “comprises,” “comprising,” or any other variation thereof, are intended to cover a non-exclusive inclusion, such that a process, method, article, or apparatus that comprises a list of elements does not include only those elements but may include other elements not expressly listed or inherent to such process, method, article, or apparatus. An element proceeded by “a” or “an” does not, without further constraints, preclude the existence of additional identical elements in the process, method, article, or apparatus that comprises the element. Furthermore, subsequent limitations referring back to “said element” or “the element” performing certain functions signifies that “said element” or “the element” alone or in combination with additional identical elements in the process, method, article or apparatus are capable of performing all of the recited functions.

The Abstract of the Disclosure is provided to allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in various examples for the purpose of streamlining the disclosure. This method of disclosure is not to be interpreted as reflecting an intention that the claims require more features than are expressly recited in each claim. Rather, as the following claims reflect, inventive subject matter lies in less than all features of a single disclosed example. Thus, the following claims are hereby incorporated into the Detailed Description, with each claim standing on its own as a separately claimed subject matter.

What is claimed is:

1. A data processing system for an autonomous mobile robot, the data processing system comprising:
a processor; and
a memory in communication with the processor, the memory comprising executable instructions that, when executed by the processor, cause the data processing system to perform functions of:
receiving three-dimensional (3D) input data generated by a sensor system of the autonomous mobile robot at an input layer of a hybrid 3D to two-dimensional (2D) Deep Convolutional Neural Network (DCNN), the hybrid 3D to 2D DCNN including a convolutional encoder network and a convolutional decoder network connected by skip connections;
successively compressing at least one dimension of the 3D input data to generate a plurality of compressed 3D feature maps using the convolutional decoder network, each of the compressed 3D feature maps having a reduced size relative to a previous compressed 3D feature map generated by the convolutional decoder network;
providing the compressed 3D feature maps generated by the convolutional decoder network to an attention-based 3D to 2D projection layer via the skip connections;
projecting the compressed 3D feature maps onto 2D bird's eye view (BEV) feature maps with the attention-based 3D to 2D projection layer to generate projected 2D BEV feature maps, the attention-based 3D to 2D projection layer automatically estimating a ground level for projected 2D BEV feature maps and identifying 3D data in the compressed 3D feature maps associated with overhanging objects that are irrelevant to ground-level navigation and omitting the identified 3D data from the projected 2D BEV feature maps;
providing the projected 2D BEV feature maps as inputs to the convolutional decoder network;
successively upsampling the projected 2D BEV feature maps to generate a plurality of upsampled 2D BEV feature maps with the convolutional decoder network, each of the upsampled 2D BEV feature maps having an increased size relative to a previously generated upsampled 2D BEV feature map;
providing a last upsampled 2D BEV feature map as a final 2D BEV feature map to a traversability analysis component;
analyzing the final 2D BEV feature map with reference to semantic class information pertaining to terrain and objects identified in the final 2D BEV feature map, terrain and object geometry information pertaining to the terrain and objects identified in the final 2D BEV feature map, and robot configuration and capability information pertaining to the autonomous mobile robot to identify a traversability level respectively for a plurality of geometric locations in the final 2D BEV feature map, the traversability level for each of the geometric locations being one of a plurality of different predefined traversability levels;
generating a 2D BEV semantic traversability prediction map that indicates the identified traversability level of the plurality of geometric locations; and
providing the 2D BEV semantic traversability prediction map to a control system of the autonomous robot to use in planning paths of movement for the autonomous mobile robot.

2. The data processing system of claim 1, wherein:
the convolutional encoder network includes a sequence of encoder layers having a first encoder layer, a last encoder layer and at least one intermediate encoder layer, each of the encoder layers generating one of the compressed 3D feature maps,
each of the encoder layers receives a 3D feature map as input and compresses the received 3D feature map to generate one of the compressed 3D feature maps,
the 3D input data corresponds to the 3D feature map used as input for the first encoder layer, and
the input 3D feature map for each encoder layer after the first encoder layer corresponds to the compressed 3D feature map generated by a previous encoder layer in the sequence of encoder layers.

3. The data processing system of claim 2, wherein each of the encoder layers performs a strided convolution to compress the 3D feature map received as input to generate one of the compressed 3D feature maps.

4. The data processing system of claim 2, wherein:
the convolutional decoder network includes a sequence of decoder layers having a first decoder layer, a last decoder layer and at least one intermediate decoder layer, each of the decoder layers having a counterpart encoder layer in the convolutional encoder network, and
each of the decoder layers receives the projected 2D BEV feature map projected by the attention-based 3d to 2D projection layer from the compressed 3D feature map generated by the counterpart encoder layer associated with the decoder layer.

5. The data processing system of claim 4, wherein:
the upsampled 2D BEV feature map generated by each of the decoder layers except for the last decoder layer is provided to a next decoder layer in the sequence of decoder layers as an input 2D BEV feature map, and
each of the decoder layers except for the first decoder layer processes (i) the input 2D BEV feature map received from a previous decoder layer in the sequence of decoder layers and (ii) the projected 2D BEV feature map received from the attention-based 3D to 2D projection layer to generate one of the upsampled 2D BEV feature maps.

6. The data processing system of claim 5, wherein:
the input 2D BEV feature map received from the previous decoder layer in the sequence of decoder layers and the projected 2D BEV feature map received from the attention-based 3D to 2D projection are combined by concatenation to generate a combined 2D BEV feature map, and
the combined 2D BEV feature map is upsampled to generated one of the upsampled 2D BEV feature maps.

7. The data processing system of claim 4, wherein:
each of the decoder layers performs a transposed convolution to generate one of the upsampled 2D BEV feature maps.

8. The data processing system of claim 1, wherein the attention-based 3D to 2D projection layer includes attention mechanisms which automatically estimate the ground level and filter out irrelevant 3D data.

9. A method for generating a 2D BEV semantic traversability prediction map for an autonomous mobile robot, the method comprising:
receiving three-dimensional (3D) input data generated by a sensor system of the autonomous mobile robot at an input layer of a hybrid 3D to two-dimensional (2D) Deep Convolutional Neural Network (DCNN), the hybrid 3D to 2D DCNN including a convolutional encoder network and a convolutional decoder network connected by skip connections;
successively compressing at least one dimension of the 3D input data to generate a plurality of compressed 3D feature maps using the convolutional decoder network, each of the compressed 3D feature maps having a reduced size relative to a previous compressed 3D feature map generated by the convolutional decoder network;
providing the compressed 3D feature maps generated by the convolutional decoder network to an attention-based 3D to 2D projection layer via the skip connections;
projecting the compressed 3D feature maps onto 2D bird's eye view (BEV) feature maps with the attention-based 3D to 2D projection layer to generate projected 2D BEV feature maps, the attention-based 3D to 2D projection layer automatically estimating a ground level for the projected 2D BEV feature maps and identifying 3D data in the compressed 3D feature maps associated with overhanging objects that are irrelevant to ground-level navigation and omitting the identified 3D data from the projected 2D BEV feature maps;
providing the projected 2D BEV feature maps as inputs to the convolutional decoder network;
successively upsampling the projected 2D BEV feature maps to generate a plurality of upsampled 2D BEV feature maps with the convolutional decoder network, each of the upsampled 2D BEV feature maps having an increased size relative to a previously generated upsampled 2D BEV feature map;
providing a last upsampled 2D BEV feature map as a final 2D BEV feature map to a traversability analysis component;
analyzing the final 2D BEV feature map with reference to semantic class information pertaining to terrain and objects identified in the final 2D BEV feature map, terrain and object geometry information pertaining to the terrain and objects identified in the final 2D BEV feature map, and robot configuration and capability information pertaining to the autonomous mobile robot to identify a traversability level respectively for a plurality of geometric locations in the final 2D BEV feature map, the traversability level for each of the geometric locations being one of a plurality of different predefined traversability levels;
generating a 2D BEV semantic traversability prediction map that indicates the identified traversability level of the plurality of geometric locations; and
providing the 2D BEV semantic traversability prediction map to a control system of the autonomous robot to use in planning paths of movement for the autonomous mobile robot.

10. The method of claim 9, wherein:
the convolutional encoder network includes a sequence of encoder layers having a first encoder layer, a last encoder layer and at least one intermediate encoder layer, each of the encoder layers generating one of the compressed 3D feature maps,
each of the encoder layers receives a 3D feature map as input and compresses the received 3D feature map to generate one of the compressed 3D feature maps,
the 3D input data corresponds to the 3D feature map used as input for the first encoder layer, and
the input 3D feature map for each encoder layer after the first encoder layer corresponds to the compressed 3D feature map generated by a previous encoder layer in the sequence of encoder layers.

11. The method of claim 10, wherein each of the encoder layers performs a strided convolution to compress the 3D feature map received as input to generate one of the compressed 3D feature maps.

12. The method of claim 10, wherein:
the convolutional decoder network includes a sequence of decoder layers having a first decoder layer, a last decoder layer and at least one intermediate decoder layer, each of the decoder layers having a counterpart encoder layer in the convolutional encoder network, and
each of the decoder layers receives the projected 2D BEV feature map projected by the attention-based 3d to 2D projection layer from the compressed 3D feature map generated by the counterpart encoder layer associated with the decoder layer.

13. The method of claim 12, wherein:
the upsampled 2D BEV feature map generated by each of the decoder layers except for the last decoder layer is provided to a next decoder layer in the sequence of decoder layers as an input 2D BEV feature map, and
each of the decoder layers except for the first decoder layer processes (i) the input 2D BEV feature map received from a previous decoder layer in the sequence of decoder layers and (ii) the projected 2D BEV feature map received from the attention-based 3D to 2D projection layer to generate one of the upsampled 2D BEV feature maps.

14. The method of claim 13, wherein:
the input 2D BEV feature map received from the previous decoder layer in the sequence of decoder layers and the projected 2D BEV feature map received from the attention-based 3D to 2D projection are combined by concatenation to generate a combined 2D BEV feature map, and
the combined 2D BEV feature map is upsampled to generated one of the upsampled 2D BEV feature maps.

15. The method of claim 12, wherein:
each of the decoder layers performs a transposed convolution to generate one of the upsampled 2D BEV feature maps.

16. The method of claim 9, wherein the attention-based 3D to 2D projection layer includes attention mechanisms which automatically estimate the ground level and filter out irrelevant 3D data.

17. A non-transitory computer readable medium on which are stored instructions that, when executed, cause a programmable device to perform functions of:
receiving three-dimensional (3D) input data generated by a sensor system of an autonomous mobile robot at an input layer of a hybrid 3D to two-dimensional (2D) Deep Convolutional Neural Network (DCNN), the hybrid 3D to 2D DCNN including a convolutional encoder network and a convolutional decoder network connected by skip connections;
successively compressing at least one dimension of the 3D input data to generate a plurality of compressed 3D feature maps using the convolutional decoder network, each of the compressed 3D feature maps having a reduced size relative to a previous compressed 3D feature map generated by the convolutional decoder network;
providing the compressed 3D feature maps generated by the convolutional decoder network to an attention-based 3D to 2D projection layer via the skip connections;
projecting the compressed 3D feature maps onto 2D bird's eye view (BEV) feature maps with the attention-based 3D to 2D projection layer to generate projected 2D BEV feature maps, the attention-based 3D to 2D projection layer automatically estimating a ground level for the projected 2D BEV feature maps and identifying 3D data in the compressed 3D feature maps associated with overhanging objects that are irrelevant to ground-level navigation and omitting the identified 3D data from the projected 2D BEV feature maps;
providing the projected 2D BEV feature maps as inputs to the convolutional decoder network;
successively upsampling the projected 2D BEV feature maps to generate a plurality of upsampled 2D BEV feature maps with the convolutional decoder network, each of the upsampled 2D BEV feature maps having an increased size relative to a previously generated upsampled 2D BEV feature map;
providing a last upsampled 2D BEV feature map as a final 2D BEV feature map to a traversability analysis component;
analyzing the final 2D BEV feature map with reference to semantic class information pertaining to terrain and objects identified in the final 2D BEV feature map, terrain and object geometry information pertaining to the terrain and objects identified in the final 2D BEV feature map, and robot configuration and capability information pertaining to the autonomous mobile robot to identify a traversability level respectively for a plurality of geometric locations in the final 2D BEV feature map, the traversability level for each of the geometric locations being one of a plurality of different predefined traversability levels;
generating a 2D BEV semantic traversability prediction map that indicates the identified traversability level of the plurality of geometric locations; and
providing the 2D BEV semantic traversability prediction map to a control system of the autonomous robot to use in planning paths of movement for the autonomous mobile robot.

18. The non-transitory computer readable medium of claim 17, wherein:
the convolutional encoder network includes a sequence of encoder layers having a first encoder layer, a last encoder layer and at least one intermediate encoder layer, each of the encoder layers generating one of the compressed 3D feature maps,
each of the encoder layers receives a 3D feature map as input and compresses the received 3D feature map to generate one of the compressed 3D feature maps,
the 3D input data corresponds to the 3D feature map used as input for the first encoder layer, and
the input 3D feature map for each encoder layer after the first encoder layer corresponds to the compressed 3D feature map generated by a previous encoder layer in the sequence of encoder layers.

19. The non-transitory computer readable medium of claim 18, wherein:
the convolutional decoder network includes a sequence of decoder layers having a first decoder layer, a last decoder layer and at least one intermediate decoder layer, each of the decoder layers having a counterpart encoder layer in the convolutional encoder network, and
each of the decoder layers receives the projected 2D BEV feature map projected by the attention-based 3d to 2D projection layer from the compressed 3D feature map generated by the counterpart encoder layer associated with the decoder layer.

20. The non-transitory computer readable medium of claim 19, wherein:
the upsampled 2D BEV feature map generated by each of the decoder layers except for the last decoder layer is provided to a next decoder layer in the sequence of decoder layers as an input 2D BEV feature map, and
each of the decoder layers except for the first decoder layer processes (i) the input 2D BEV feature map received from a previous decoder layer in the sequence of decoder layers and (ii) the projected 2D BEV feature map received from the attention-based 3D to 2D projection layer to generate one of the upsampled 2D BEV feature maps.
